(19) United States
(12) Patent Application Publication
(10) Pub. No.: US 2018/0089779 A1
(43) Pub. Date: Mar. 29, 2018

(54) SKILL-BASED RANKING OF ELECTRONIC COURSES

(71) Applicant: Linkedln Corporation, Mountain View, CA (US)

(72) Inventor: Krishnaram Kenthapadi, Sunnyvale, CA (US)

(21) Appl. No.: 15/295,136

(22) Filed: Oct. 17, 2016

Related U.S. Application Data
(60) Provisional application No. 62/401,592, filed on Sep. 29, 2016.

(51) Int. Cl. G06Q 50/20; H04L 29/08; G06Q 50/00; G06F 17/30

(52) U.S. Cl. CPC G06Q 50/2053; H04L 67/10; H04L 67/306; H04L 67/42; G06Q 50/01; G06F 17/30867; H04L 67/22

(57) ABSTRACT

A course relevance evaluator is provided with an on-line social network system. The course relevance evaluator generates a model for predicting importance of an electronic course for imparting a certain skill. The model takes, as input, features related to the content and metadata of a given electronic course together with previously-captured data that reflects how various members of the on-line social network historically interacted with the course. This methodology and the resulting relevance values generated for skill-course pairs can be used in the context of a job search or, e.g., in the process of identifying relevant electronic courses that could be recommended to a viewer of an electronic presentation.

### CROSS-REFERENCE TO RELATED APPLICATIONS

This application claims the benefit of U.S. Provisional Application No. 62/401,592, filed Sep. 29, 2016, which is incorporated herein by reference in its entirety.

### TECHNICAL FIELD

This application relates to the technical fields of software and/or hardware technology and, in one example embodiment, to system and method to generate a relevance value for a course with respect to imparting a certain skill.

### BACKGROUND

An electronic course is a useful teaching and learning tool for imparting knowledge and also professional skills. Electronic courses may be made available to computer users via an on-line social network. An on-line social network is a platform for connecting people in virtual space. An on-line social network may be a web-based platform, such as, e.g., a social networking web site, and may be accessed by a user via a web browser or via a mobile application provided on a mobile phone, a tablet, etc. An on-line social network may be a business-focused social network that is designed specifically for the business community, where registered members establish and document networks of people they know and trust professionally. Each registered member may be represented by a member profile. A member profile may be represented by one or more web pages, or a structured representation of the member's information in XML (Extensible Markup Language), JSON (JavaScript Object Notation) or similar format. A member's profile web page of a social networking web site may emphasize employment history and professional skills of the associated member.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to generate a relevance value for a course with respect to imparting a certain skill may be implemented;

FIG. 2 is block diagram of a system to generate a relevance value for a course with respect to imparting a certain skill, in accordance with one example embodiment;

FIG. 3 is a flow chart illustrating a method to generate a relevance value for a course with respect to imparting a certain skill, in accordance with an example embodiment; and

FIG. 4 is a diagrammatic representation of an example machine in the form of a computer system within which a set of instructions, for causing the machine to perform any one or more of the methodologies discussed herein, may be executed.

### DETAILED DESCRIPTION

A method and system to generate a relevance value for a course with respect to imparting a certain skill is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

Electronic courses (also referred to as simply courses for the purposes of this description) can be made available to computer users to help them enhance existing professional skills, as well as to learn new ones. It may be beneficial to automatically determine how useful is a given course in teaching a particular skill. A skill, for the purposes of this description is an item of information that represents a skill of a member in an on-line social network system and that is stored in a skills database maintained by the on-line social network system. Each skill-related entry in the skills database includes a phrase (e.g., “programming” or “patent prosecution”) that can appear in a member profile maintained by the on-line social network system in one or more designated profile sections, such as, e.g., in the skills and endorsements section of a profile.

For the purposes of this description the phrases “an on-line social networking application” and “an on-line social network system” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. Each member of an on-line social network is represented by a member profile (also referred to as a profile of a member or simply a profile). A member profile may be associated with social links that indicate the member's connection to other members of the social network. A member profile may also include or be associated with comments or recommendations from other members of the on-line social network, with links to other network resources, such as, e.g., publications, etc. As mentioned above, an on-line social networking system may be designed to allow registered members to establish and document networks of people they know and trust professionally. Any two members of a social network may indicate their mutual willingness to be “connected” in the context of the social network, in that they can view each other's profiles, profile recommendations and endorsements for each other and otherwise be in touch via the social network. Members that are connected in this way to a particular member may be referred to as that particular member's connections or as that particular member's network. The profile information of a social network member may include various information such as, e.g., the name of a member, current and previous geographic location of a member, current and previous employment information of a member, information related to education of a member, information about professional accomplishments of a member, publications, patents, etc. As mentioned above, the profile information of a social network member may also include information about the member's professional skills.

In one embodiment, the system to generate a relevance value for a course with respect to imparting a certain skill is implemented as a so-called course relevance evaluator that is provided as part of or associated with the on-line social network system. The course relevance evaluator generates a model for predicting importance of an electronic course for imparting a certain skill. In order to learn a model for predicting importance of an electronic course for imparting a certain skill, the course relevance evaluator processes content and metadata of a given electronic course together with historical data that reflects how various members of the on-line social network interacted with the course. This methodology and the resulting relevance values generated for skill-course pairs can be used in the context of a job search where a user who searches for a job may be lacking a skill required for a job they hope to get. The relevance values generated for skill-course pairs can also be used in the context where users are searching for electronic courses that would help them learn certain skills, or, e.g., in the process of identifying relevant electronic courses that could be recommended to a viewer of an electronic presentation.

In one embodiment, the system to generate a relevance value for a course with respect to imparting a certain skill is implemented as a so-called course relevance evaluator that is provided as part of or associated with the on-line social network system. The relevance value generated for a course with respect to imparting a certain skill may be referred to as a weight for a skill-course pair. An example method to generate the weight w(v, c) of a course v for imparting a skill c is described bellow.

For each course v, the course relevance evaluator creates a candidate set of skills associated with the course by examining content and metadata of the subject course and selecting any phrases that appear in the course that also represent a skill entry in the skills database maintained by the on-line social network system. The candidate set of skills is used to create a set of skill-course pairs. The course relevance evaluator then determines respective weights each skill-course pair using supervised machine learning approach. As stated above, a weight w(v, c) indicates relevance of a course v for imparting a skill c.

In the supervised learning approach, the course relevance evaluator learns a model to predict the weight of course v for imparting skill c using a machine learning algorithm (such as, e.g., logistic regression), based on a labeled ground truth dataset. The ground truth dataset can be obtained automatically by monitoring users' activity in the on-line social network system with respect to electronic courses (provided the corresponding signal, such as, e.g., the average user rating, is not used as an input feature into the learned model).

The model generated by the course relevance evaluator, which can be referred to as the course relevance evaluator model, takes, as input, features related to characteristics of the subject course, features indicative of any references to the subject skill in the subject course, as well as user feedback signals with respect to the subject course. Base on the input related to a course v and a skill c, the course relevance evaluator model generates the associated weight w(v, c). The weight w(v, c) can be stored as associated with the course v, as associated with a skill c, or as associated with the skill-course pair (v, c), for future use.

Examples of features related to characteristics of the subject course include reputation of the author of the course (e.g., the average rating of the author in the on-line social network system), popularity of the author of the course (e.g., the number of views of courses by that author), and the total number of courses created by the author of the course. Other examples of features related to characteristics of the subject course include reputation of the provider of the course (e.g., the average rating in the on-line social network system of the company that provides the course), popularity of the provider of the course (e.g., the number of views of courses by that author), and the total number of courses offered by the provider of the course. These course-related features may be restricted to the recent past, e.g., they may be used only as long as the information is less than one month old. Still more examples of features related to characteristics of the subject course are popularity of the course (e.g., measured by the number of views), popularity of the course within the last n days, trend/change in the popularity of the course, rating of the course in the on-line social network system, quality of the course video (e.g., whether the associated video has been professionally created, screencapture versus shot with a camera, whether animation is used, etc.), quality of the course audio, quality of the course transcript (e.g., readability of an index denoting the ease of comprehension of the material in the course transcript), etc.

Other features that the course relevance evaluator model can take as input include so-called skill-course features. Examples of skill-course features include an indication of whether the skill (or a related skill) has been listed by the author of the course under objectives of the course, features based on the occurrence of references to the skill in the course, etc. Yet another category of features that the course relevance evaluator model can take as input include user feedback signals. User feedback signals include popularity (measured, e.g., as the click-through-rate for the given course when users search for courses related the skill), average user rating of the course in the on-line social network system, endorsement features (e.g., the rate/number of the on-line social network members pinning/sharing the course as related to the skill). As with respect to course-related features, these skill-course features may be restricted to the recent past, e.g., they may be used only as long as the information has been provided within a certain predetermined period of time.

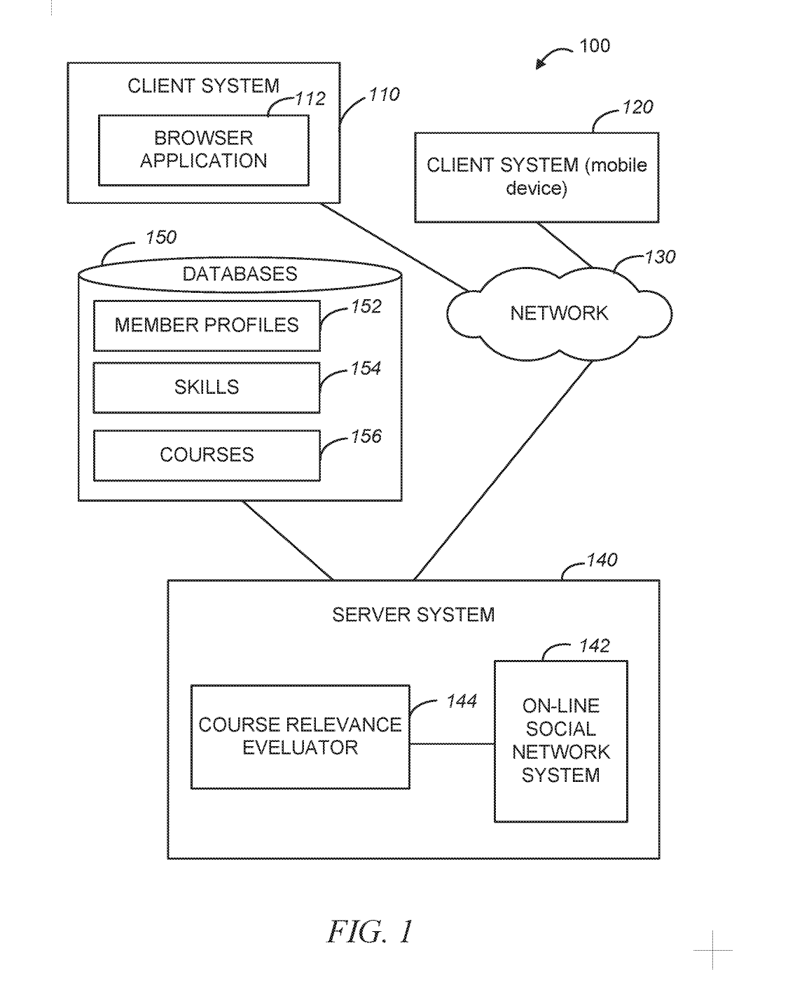

As mentioned above, the resulting relevance values generated for skill-course pairs can be used in the context of a job search, in the scenario where users are searching for electronic courses that would help them learn certain skills, in the process of identifying electronic courses that would be of interest to a viewer of an electronic presentation, etc. For example, respective weights for skill-course pairs may be utilized by a so-called course recommendation system in the process of identifying relevant courses to be recommended to a viewer of an electronic presentation. The course recommendation system may be configured to determine which skills are being discussed in a presentation and to what extent, access course identifications and their respective weights assigned to different skills, and select one or more most relevant courses with respect to the presentation, based on their respective weights. The relevance value generated for a course with respect to imparting a certain skill may also be used to determine whether to recommend the course to a user who has submitted a job search request for a job that requires certain skills. An example course relevance evaluator may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in databases 150 as member profiles 152. Also included in the databases 150 is a skills database 154 maintained by the on-line social network system 142. It will be noted that, in some embodiments, the databases 150 may be distributed across multiple computer systems that may reside at different geographic locations.

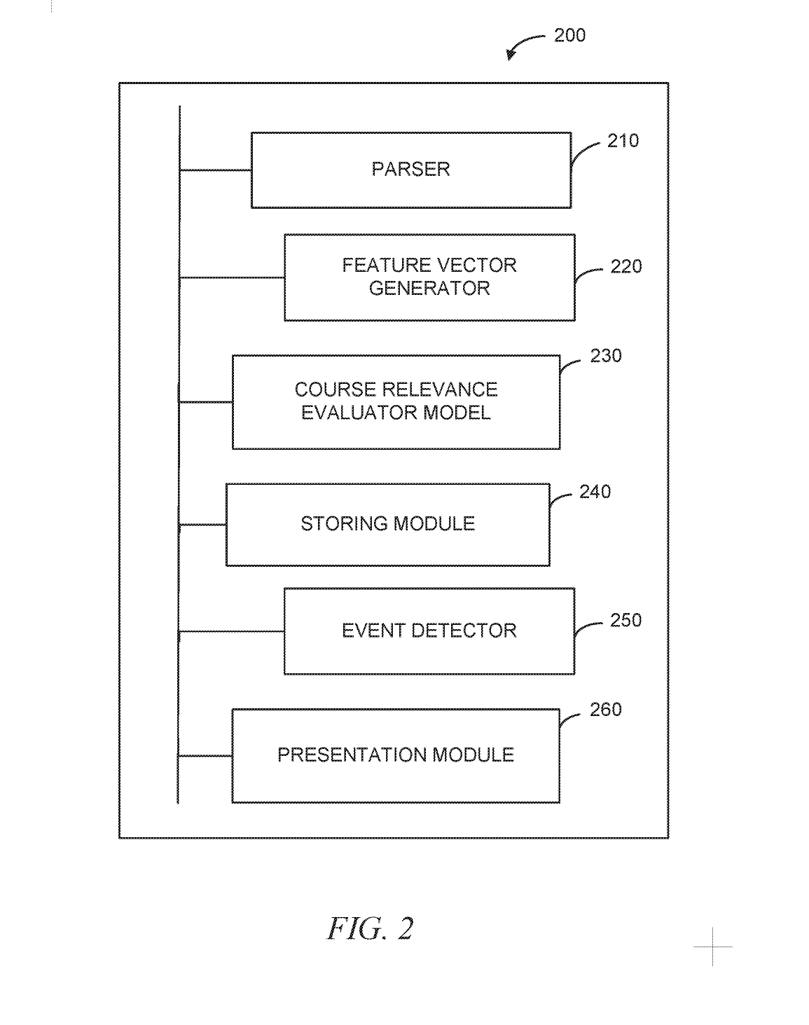

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a course relevance evaluator 144. The course relevance evaluator 144 is configured to learn a model for predicting importance of an electronic course for imparting a certain skill. As discussed above, the model takes, as input, features generated based on the content and metadata of a given electronic course together with historical data that reflects how various members of the on-line social network historically interacted with the course. The resulting relevance values may be stored for future use as associated with courses 156 in the database 150. An example course relevance evaluator 144 is illustrated in FIG. 2.

FIG. 2 is a block diagram of a system 200 to generate a relevance value for a course with respect to imparting a certain skill. As shown in FIG. 2, the system 200 includes a parser 210, a feature vector generator 220, a course relevance evaluator model 230, and a storing module 240. The parser 210 is configured to examine an electronic course to identify one or more phrases representing respective one or more skills that correspond to respective entries in the skills database 154 of FIG. 1. The skills database 154 is maintained by an on-line social network system 142. The feature vector generator 220 is configured to generate a feature vector comprising features, such as features related to characteristics of the electronic course, features related to a particular skill from the one or more skills, features related to user feedback with respect to the electronic course, etc., as discussed in more detail above. The course relevance evaluator model 230 is configured to produce a relevance value with respect to the electronic course and the subject skill using the feature vector as input. As explained above, the course relevance evaluator model 230 can be learned using historical data indicative of interaction of one or more members of the on-line social network system 142 with the electronic course in the on-line social network system. The storing module 240 is configured to store the produced relevance value as associated with the electronic course, or as associated with the subject skill, or as associated with the pair comprising the electronic course and the subject skill, for future use.

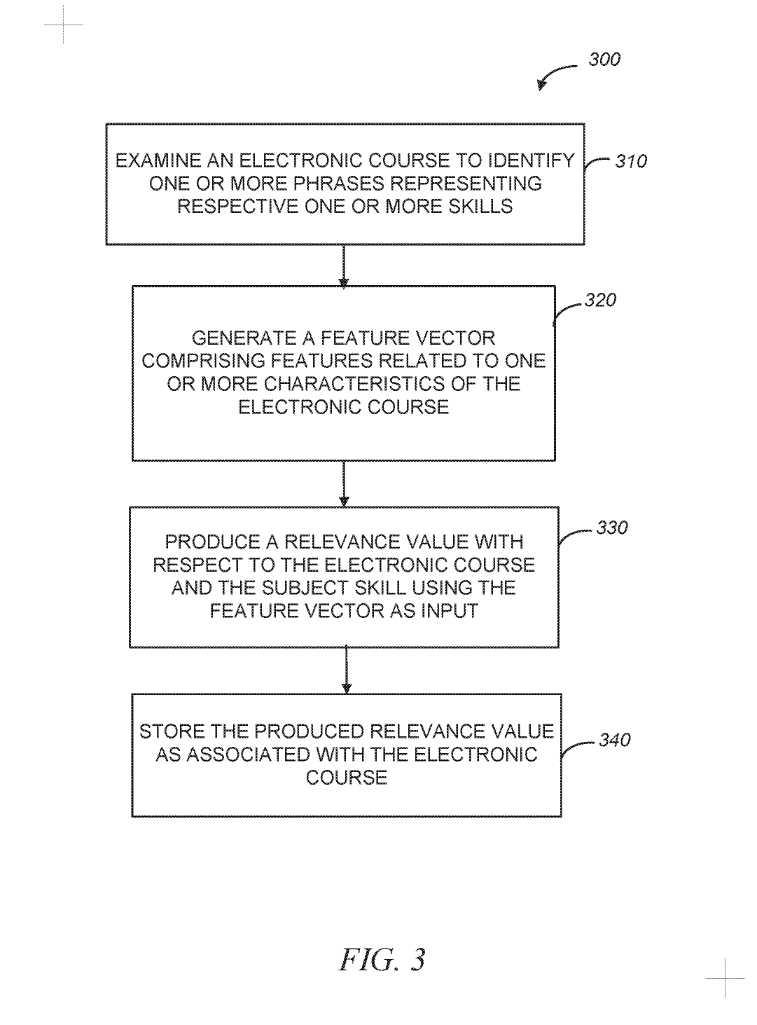

Also shown in FIG. 2 are an event detector 250 and a presentation module 260. The event detector 250 is configured to detect an event indicative of a presentation on a display device that could be enhanced with a further presentation related to the electronic course. The presentation module 260 is configured to selectively display such further presentation based on the relevance value generated with respect to the electronic course. For example, the event detector 250 detects an event indicating rendering of an electronic presentation associated with the subject skill on a display device, and the presentation module 260 causes display of a recommendation with respect to the electronic course together with the electronic presentation if the produced relevance value is greater than a predetermined threshold. As another example, the event detector 250 detects a job search result associated with the subject skill, and the presentation module 260 causes display of a recommendation with respect to the electronic course together with the search result if the produced relevance value is greater than a predetermined threshold. As yet another example, the event detector 250 detects a reference to the electronic course in search results, and the presentation module 260 causes decorates the reference to the electronic course in the search results with a reference to the subject skill and the produced relevance value. Some operations performed by the system 200 may be described with reference to FIG. 3.

FIG. 3 is a flowchart of a method 300 to generate a relevance value for a course with respect to imparting a certain skill. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the parser 210 of FIG. 2 examines an electronic course to identify one or more phrases representing respective one or more skills that correspond to respective entries in the skills database 154 of FIG. 1. At operation 320, the feature vector generator 220 of FIG. 2 generates a feature vector based on various features discussed above. The course relevance evaluator model 230 of FIG. 2 produces a relevance value with respect to the electronic course and the subject skill using the feature vector as input, at operation 330. At operation 340, the storing module 240 of Fig stores the produced relevance value for future use.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

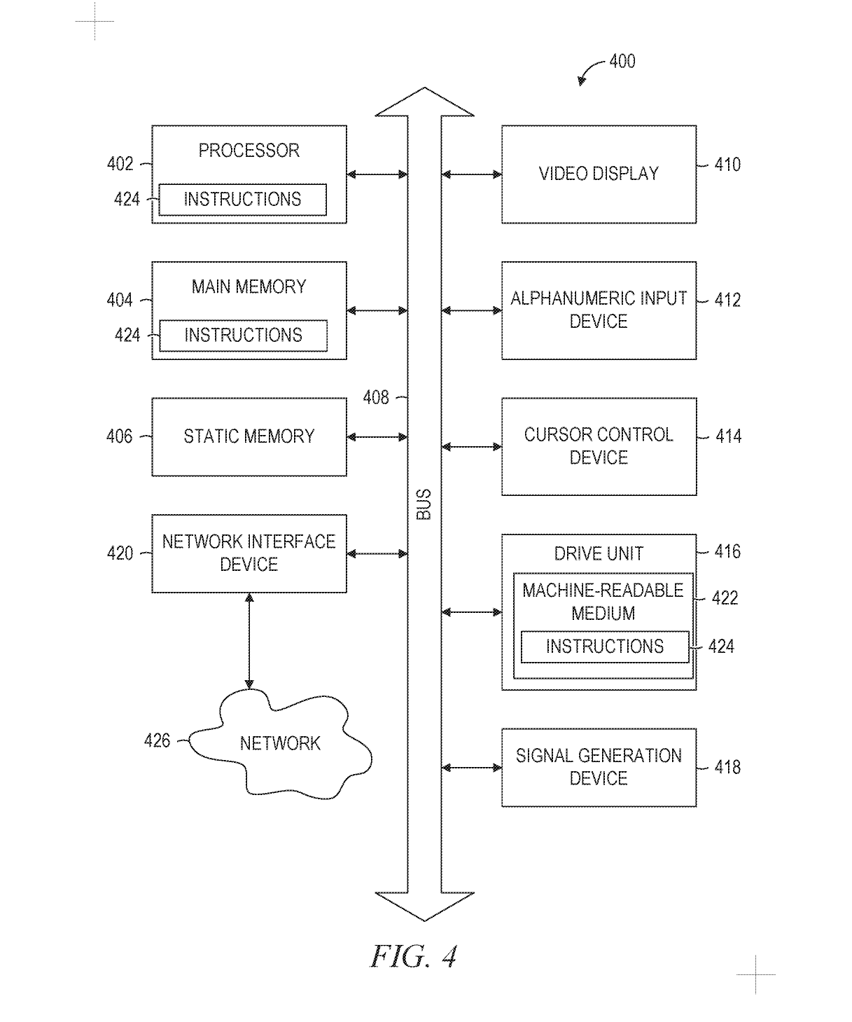

FIG. 4 is a diagrammatic representation of a machine in the example form of a computer system 400 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 404. The computer system 400 may further include a video display unit 410 (e.g., a liquid crystal display (LCD) or a cathode ray tube (CRT)). The computer system 400 also includes an alpha-numeric input device 412 (e.g., a keyboard), a user interface (UI) navigation device 414 (e.g., a cursor control device), a disk drive unit 416, a signal generation device 418 (e.g., a speaker) and a network interface device 420.

The disk drive unit 416 includes a machine-readable medium 422 on which is stored one or more sets of instructions and data structures (e.g., software 424) embodying or utilized by any one or more of the methodologies or functions described herein. The software 424 may also reside, completely or at least partially, within the main memory 404 and/or within the processor 402 during execution thereof by the computer system 400, with the main memory 404 and the processor 402 also constituting machine-readable media.

The software 424 may further be transmitted or received over a network 426 via the network interface device 420 utilizing any one of a number of well-known transfer protocols (e.g., Hyper Text Transfer Protocol (HTTP)).

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only, memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially^{,} processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, a method and system to generate a relevance value for a course with respect to imparting a certain skill has been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer implemented method comprising:
examining an electronic course to identify one or more phrases representing respective one or more skills that correspond to respective entries in a skills database, the skills database maintained by an on-line social network system, a profile from member profiles maintained by the on-line social network system comprising a skills section populated with one or more values corresponding to respective entries the skills database;
generating a feature vector comprising features related to one or more characteristics of the electronic course, a subject skill from the one or more skills and user feedback related to the electronic course; and
using at least one processor, executing a course relevance evaluator model to produce a relevance value with respect to the electronic course and the subject skill using the feature vector as input, the course relevance evaluator model learned using historical data indicative of interaction of one or more members of the on-line social network system with the electronic course in the on-line social network system.

2. The method of claim 1, wherein a dimension in the feature vector is a characteristic of the electronic course.

3. The method of claim 1, wherein a dimension in the feature vector is related to an author or a provider of the electronic course.

4. The method of claim 1, wherein a dimension in the feature vector is a feedback signal in the on-line social network with respect to the electronic course.

5. The method of claim 1, wherein a dimension in the feature vector is related to a technical quality of the electronic course.

6. The method of claim 5, wherein a dimension in the feature vector indicates video quality of the electronic course.

7. The method of claim 1, comprising:
detecting an event indicating rendering of an electronic presentation on a display device, the electronic presentation associated with the subject skill; and
based on the produced relevance value, determining whether to display a recommendation with respect to electronic course together with the electronic presentation.

8. The method of claim 1, comprising:
detecting a job search result associated with the subject skill; and
based on the produced relevance value, determining whether to display a recommendation with respect to electronic course together with the job search result.

9. The method of claim 1, comprising:
detecting a reference to the electronic course in search results; and
decorate the reference to the electronic course in the search results with a reference to the subject skill and the produced relevance value.

10. The method of claim 1, wherein the electronic course is accessible from a web site provided by the on-line social network system.

11. A computer-implemented system comprising:
a parser, implemented using at least one processor, to examine an electronic course to identify one or more phrases representing respective one or more skills that correspond to respective entries in a skills database_{;} the skills database maintained by an on-line social network system, a profile from member profiles maintained by the on-line social network system comprising a skills section populated with one or more values corresponding to respective entries the skills database;
a feature vector generator, implemented using at least one processor, to generate a feature vector comprising features related to one or more characteristics of the electronic course, a subject skill from the one or more skills and user feedback related to the electronic course; and
a course relevance evaluator model, implemented using at least one processor, to produce a relevance value with respect to the electronic course and the subject skill using the feature vector as input, the course relevance evaluator model learned using historical data indicative of interaction of one or more members of the on-line social network system with the electronic course in the on-line social network system.

12. The system of claim 11, wherein a dimension in the feature vector is a characteristic of the electronic course.

13. The system of claim 11, wherein a dimension in the feature vector is related to an author or a provider of the electronic course.

14. The system of claim 11, wherein a dimension in the feature vector is a feedback signal in the on-line social network with respect to the electronic course.

15. The system of claim 11, wherein a dimension in the feature vector is related to a technical quality of the electronic course.

16. The system of claim 15, wherein a dimension in the feature vector indicates video quality of the electronic course.

17. The system of claim 11, comprising:
an event detector, implemented using at least one processor, to detect an event indicating rendering of an electronic presentation on a display device, the electronic presentation associated with the subject skill; and
a presentation module, implemented using at least one processor, to selectively cause display a recommendation with respect to electronic course together with the electronic presentation based on the produced relevance value.

18. The system of claim 11, comprising:
an event detector, implemented using at least one processor, to detect a job search result associated with the subject skill; and
a presentation module, implemented using at least one processor_{;} to selectively cause display a recommendation with respect to electronic course together with the job search result based on the produced relevance value.

19. The system of claim 11, comprising:
an event detector, implemented using at least one processor, to detect a reference to the electronic course in search results; and
a presentation module, implemented using at least one processor, to decorate the reference to the electronic course in the search results with a reference to the subject skill and the produced relevance value.

20. A machine-readable non-transitory storage medium having instruction data executable by a machine to cause the machine to perform operations comprising:
examining an electronic course to identify one or more phrases representing respective one or more skills that correspond to respective entries in a skills database, the skills database maintained by an on-line social network system, a profile from member profiles maintained by the on-line social network system comprising a skills section populated with one or more values corresponding to respective entries the skills database;
generating feature vector comprising features related to one or more characteristics of the electronic course, a subject skill from the one or more skills and user feedback related to the electronic course; and
executing a course relevance evaluator model, implemented using at least one processor, to produce a relevance value with respect to the electronic course and the subject skill using the feature vector as input; the course relevance evaluator model learned using historical data indicative of interaction of one or more members of the on-line social network system with the electronic course in the on-line social network system.
